(19) United States
(12) Patent Application Publication
(10) Pub. No.: US 2026/0068001 A1
(43) Pub. Date: Mar. 5, 2026

(54) AEROSOL-GENERATING DEVICE AND HEATING STRUCTURE THEREOF

(71) Applicant: SMOORE INTERNATIONAL HOLDINGS LIMITED, George Town (KY)

(72) Inventors: Guo ZHANG, Shenzhen (CN); Lei MA, Shenzhen (CN); Xingfu ZHANG, Shenzhen (CN); Xianwu DU, Shenzhen (CN); Hongming ZHOU, Shenzhen (CN); Rihong LI, Shenzhen (CN); Xiaohua ZHANG, Shenzhen (CN); Pengfei HUANG, Shenzhen (CN)

(21) Appl. No.: 19/383,502

(22) Filed: Nov. 7, 2025

Related U.S. Application Data
(63) Continuation of application No. PCT/CN2024/091486, filed on May 7, 2024.

(30) Foreign Application Priority Data
May 9, 2023 (CN) 202310525486.X

(51) Int. Cl. H05B 3/44; A24F 40/46

(52) U.S. Cl. CPC H05B 3/44; A24F 40/46; H05B 2203/007; H05B 2203/032

(57) ABSTRACT

A heating structure includes: a heating element; and a tube body. The heating element and a tube wall of the tube body are at least partially spaced apart. The heating element is electrically heated and radiates infrared light to transmit through the tube body and heats an aerosol-generating substrate. The tube body includes a first portion and a second portion that are distributed along an axial direction of the tube body. The first portion reaches a higher temperature than a temperature than the second portion when the heating element is energized.

### CROSS-REFERENCE TO PRIOR APPLICATION

This application is a continuation of International Patent Application No. PCT/CN2024/091486, filed on May 7, 2024, which claims priority to Chinese Patent Application No. 202310525486.X, filed on May 9, 2023. The entire disclosure of both applications is hereby incorporated by reference herein.

### FIELD

The present invention relates to the field of heat-not-burn products, and in particular to an aerosol-generating device and a heating structure thereof.

### BACKGROUND

In the field of heat-not-burn (HNB) products, a central heating structure uses a heating element disposed inside a quartz tube. When the heating element is connected to a power supply, the heating element radiates infrared light outward and heats an aerosol-generating substrate. The temperature field distribution of the heating structure has a very important impact on the consistency of the vaping experience and the amount of aerosol generated. Therefore, when the infrared light is used to heat the aerosol-generating substrate, the rationality of the temperature field distribution of the heating element and the quartz glass tube is very important.

### SUMMARY

In an embodiment, the present invention provides a heating structure, comprising: a heating element; and a tube body, wherein the heating element and a tube wall of the tube body are at least partially spaced apart, wherein the heating element is electrically heated and configured to radiate infrared light to transmit through the tube body and heats an aerosol-generating substrate, wherein the tube body comprises a first portion and a second portion that are distributed along an axial direction of the tube body, and wherein the first portion and the second portion are configured, such that, when the heating element is energized, the first portion reaches a higher temperature than a temperature than the second portion.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of an aerosol-generating device according to some embodiments of the present invention;

FIG. 2 is a cross-sectional view of a heating structure according to some embodiments of the present invention;

FIG. 3 is a schematic structural diagram of a heating element according to some embodiments of the present invention;

FIG. 4 is a transverse cross-sectional view of a heating element according to some embodiments of the present invention;

FIG. 5 is a schematic structural diagram of a heating portion according to a first embodiment of the present invention;

FIG. 6 is a schematic structural diagram of a heating portion according to a second embodiment of the present invention;

FIG. 7 is a schematic structural diagram of a heating portion according to a third embodiment of the present invention;

FIG. 8 is a schematic structural diagram of a heating portion according to a fourth embodiment of the present invention;

FIG. 9 is a schematic structural diagram of a heating portion according to a fifth embodiment of the present invention; and

FIG. 10 is a schematic structural diagram of a heating portion according to a sixth embodiment of the present invention.

### DETAILED DESCRIPTION

In an embodiment, the present invention provides an improved heating structure.

In an embodiment, the present invention provides a heating structure including a heating element and a tube body. The heating element and the tube wall of the tube body are at least partially spaced apart, the heating element is electrically heated and configured to radiate infrared light, and the infrared light is transmitted through the tube body and heats an aerosol-generating substrate.

The tube body includes a first portion and a second portion that are distributed along the axial direction of the tube body, and the first portion and the second portion are configured to heat the first portion to a higher temperature than that of the second portion when the heating element is energized.

Preferably, the tube body includes a closed end and an open end, the heating element extends into the tube body from the open end and is in contact with or spaced apart from the closed end, the first portion is close to the closed end, and the second portion is close to the open end.

Preferably, the maximum operating temperature of the first portion ranges from 350° C. to 550° C., and the maximum operating temperature of the second portion is less than or equal to 250° C.

Preferably, the length of the first portion is greater than or equal to the length of the second portion.

Preferably, the length of the first portion ranges from 5 mm to 12 mm, and the length of the second portion ranges from 4 mm to 10 mm; or a ratio of the length of the first portion to the length of the second portion is greater than or equal to 1 and less than or equal to 2.

Preferably, the heating element is longitudinally disposed, the heating element includes a heating portion close to the closed end and an electrically conductive portion connected to the heating portion, and a ratio of the length of the first portion to the length of the heating portion is greater than or equal to 0.8 and less than or equal to 1.5.

Preferably, the maximum operating temperature of the heating portion is 500° C. to 1200° C., and the maximum operating temperature of the electrically conductive portion ranges from 150° C. to 450° C.

Preferably, the heating portion includes at least a plurality of spiral segments connected in sequence.

Preferably, a top end and a pin end are respectively disposed at two ends of the heating portion, the pin end is electrically connected to the electrically conductive portion, the top end is in contact with or spaced apart from the inner wall of the closed end, and the temperatures of at least some of the spiral segments are higher than the temperatures of the top end and the pin end.

Preferably, the lengths of the spiral segments range from 5 mm to 12 mm, and the gap between the spiral segments and the inner wall of the tube body ranges from 0.05 mm to 0.5 mm.

Preferably, the plurality of spiral segments are disposed equidistantly or in an alternating sparse-dense pattern.

Preferably, the heating structure further includes a mounting base for fixing the tube body, and the mounting base is located at the second portion. The heating element further includes a connection portion connecting the heating portion and the electrically conductive portion, and the mounting base is located between the open end and the connection portion in the axial direction of the tube body and is spaced apart from the connection portion.

Preferably, the distance between the connection portion and the mounting base ranges from 2 mm to 10 mm.

Preferably, the second portion covers the end of a portion of the heating portion close to the electrically conductive portion.

Preferably, the first portion covers the end of a portion of the electrically conductive portion close to the heating portion.

Preferably, the tube body is configured to be at least partially inserted into the aerosol-generating substrate, and the infrared light generated by the heating element is transmitted through the tube body and heats the aerosol-generating substrate.

Preferably, the heating element includes a heating substrate and an infrared radiation layer disposed on the outer surface of the heating substrate, and the heating substrate is electrically heated and configured to excite the infrared radiation layer to radiate infrared light.

The present invention further constructs an aerosol-generating device, including the above-mentioned heating structure and a power supply assembly for supplying power to the heating structure.

The implementation of the present invention has the following beneficial effects. When the heating element generates heat in the energized state, the heating element can radiate infrared light. The infrared light can be transmitted through the tube body to the aerosol-generating substrate and heat the aerosol-generating substrate, not only preventing the aerosol-generating substrate from being overheated, but also greatly improving the vaping experience. The temperature of the first portion of the tube body is higher than that of the second portion, thereby forming a temperature field distribution with a gradient difference, which can improve the consistency of the vaping experience and increase the amount of aerosol generated.

To provide clearer understanding of the technical features, objectives, and effects of the present invention, particular implementations of the present invention are described in detail with reference to the accompanying drawings. In the following description, it should be understood that orientation or position relationships indicated by the terms such as “front”, “rear”, “up”, “down”, “left”, “right”, “longitudinal”, “transverse”, “vertical”, “horizontal”, “top”, “bottom”, “inner”, “outer”, “head”, and “tail” are based on orientation or position relationships illustrated in the accompanying drawings, constructed and operated in a particular orientation, and merely intended to facilitate the description of the technical solution, instead of indicating that the device or element referred to must have a particular orientation. Thus, such terms should not be interpreted as limiting the present invention.

It should be further noted that, unless otherwise clearly specified and limited, terms such as “mounted”, “connected”, “connection”, “fixed”, and “disposed” should be understood in a generalized manner, for example, may be understood as a fixed connection, a detachable connection, or integration; or may be understood as a mechanical connection or an electrical connection; or may be understood as a direct connection, an indirect connection via a medium, an internal communication of two elements, or a mutual relationship between two elements. When an element is referred to as being “above” or “below” another element, the element can be “directly” or “indirectly” located above the another element, or one or more intervening elements may exist. The terms such as “first”, “second”, and “third” are merely for facilitating the description of the technical solution, and should not be interpreted as indicating or implying relative importance or implicitly indicating the number of the technical features indicated. Thus, the features defined with “first”, “second”, “third”, etc. can explicitly or implicitly include one or more such features. A person of ordinary skill in the art may understand the specific meanings of the foregoing terms in the present invention according to specific situations.

In the following description, for the purpose of description rather than limitation, specific details such as the specific system structure and technology are provided to thoroughly understand the present invention. However, it should be clear to those skilled in the art that the present invention may also be implemented in other embodiments without these specific details. In other cases, detailed descriptions of known systems, devices, circuits, and methods are omitted to avoid unnecessary details hindering the description of the present invention.

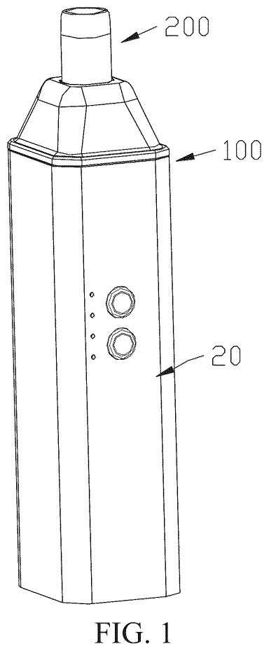

FIG. 1 shows an aerosol-generating device according to some embodiments of the present invention. The aerosol-generating device 100 may heat an aerosol-generating substrate 200 in a low-temperature HNB manner, and has good aerosol generation stability and good aerosol taste. In some embodiments, the aerosol-generating substrate 200 may be disposed on the aerosol-generating device 100 in a pluggable manner. The aerosol-generating substrate 200 may be columnar. Specifically, the aerosol-generating substrate may be a solid material in the shape of a filament, sheet or one-piece molding that is made of leaves and/or stalks of a plant (such as tobacco), and an aroma component may be further added to the solid material. Further, the aerosol-generating device 100 includes a heating structure and a power supply component 20. The power supply component 20 is configured to supply power to the heating structure.

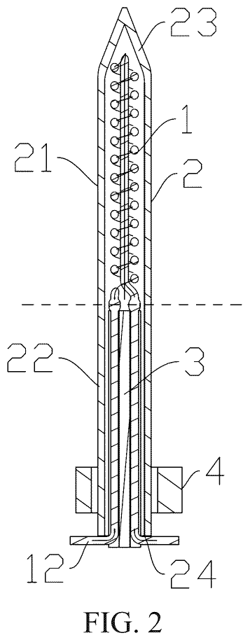

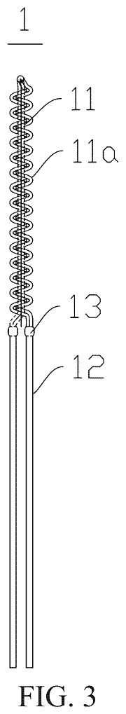

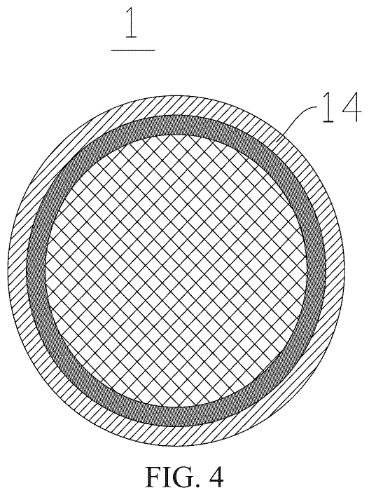

FIGS. 2 to 4 show a heating structure according to some embodiments of the present invention. The heating structure may be configured to be partially inserted into an aerosol-generating substrate 200. Specifically, the heating structure may be partially inserted into a substrate segment of the aerosol-generating substrate 200, and generates infrared light in the energized state to heat the substrate segment of the aerosol-generating substrate 200, so that the substrate segment is heated to generate aerosol. The heating structure may include a heating element 1 and a tube body 2. The heating element 1 is longitudinally disposed and may include a heating portion 11 and an electrically conductive portion 12 that are connected to each other. The heating portion 11 is configured to be electrically heated and excite an infrared radiation layer 14 to radiate infrared light. The heating element 1 and the tube wall of the tube body 2 are spaced apart. The tube body 2 is disposed to cover at least part of the heating element 1, and may allow light waves to penetrate into the aerosol-generating substrate 200. Specifically, in the present embodiment, the tube body 2 may allow the infrared light to penetrate through, thereby facilitating the radiation of the infrared light from the heating element 1 to heat the aerosol-generating substrate 200.

In some embodiments, the heating element 1 includes a heating substrate and an infrared radiation layer 14 wrapped around the heating substrate. The heating substrate includes a metal substrate with high-temperature oxidation resistance, such as a metal wire. The heating substrate can be metal materials with good high-temperature oxidation resistance and high stability, and resistance to deformation, such as a nickel-chromium alloy substrate (such as a nickel-chromium alloy wire), an iron-chromium-aluminum alloy substrate (such as an iron-chromium-aluminum alloy wire), or the like. In some embodiments, the diameter of the metal wire may range from 0.15 mm to 0.8 mm, inclusive. The metal wire may be bent or wound into various shapes, such as a spiral shape, a mesh shape, an M shape, or an N shape. The bent or wound heating element has a columnar shape, a spiral segment, a mesh shape, or other three-dimensional or planar shape with bends as a whole.

In some embodiments, the heating element 1 further includes an anti-oxidation layer, and the anti-oxidation layer is formed between the heating substrate and the infrared radiation layer 14. Specifically, the anti-oxidation layer may be an oxide film. The heating substrate is subject to high-temperature heat treatment, a dense oxide film is formed on the surface of the heating substrate, and the oxide film forms the anti-oxidation layer. Certainly, it may be understood that, in some other embodiments, the anti-oxidation layer is not limited to including the oxide film formed by itself. In some other embodiments, the anti-oxidation layer may be an anti-oxidation coating applied to the outer surface of the heating substrate. The thickness of the anti-oxidation layer may be chosen to range from 1 μm to 150 μm, including 1 μm and 50 μm.

In some embodiments, the infrared radiation layer 14 may be an infrared layer. The infrared layer may be formed on the side of the anti-oxidation layer away from the heating substrate by an infrared layer-forming substrate through high-temperature heat treatment. Specifically, the infrared layer-forming substrate may be silicon carbide, spinel, or a composite-like substrate thereof. Certainly, it may be understood that, in some other embodiments, the infrared radiation layer is not limited to the infrared layer. In some other embodiments, the infrared radiation layer may be a composite infrared layer. Specifically, the infrared layer may be formed on the side of the anti-oxidation layer away from the heating substrate through dip coating, spray coating, brush coating, and other methods. The thickness of the infrared radiation layer may range from 10 μm to 300 μm, inclusive.

Preferably, the tube body 2 may be a quartz glass tube. Certainly, it may be understood that, in some other embodiments, the tube body 2 is not limited to a quartz tube, or may be other window material that may allow light waves to penetrate through, for example, transparent infrared glass, transparent ceramics, or diamond.

In some embodiments, the tube body 2 is in the shape of a hollow tube and has two ends distributed along the axial direction. Specifically, the tube body 2 includes a first portion 21 and a second portion 22 distributed along the axial direction of the tube body 2, as well as a closed end 23 close to the first portion 21 and an open end 24 close to the second portion 22. The heating element 1 extends from the open end 24 into the tube body 2 and is in contact with or spaced apart from the closed end 23. Preferably, the length of the first portion 21 is greater than or equal to the length of the second portion 22, and the length of the first portion 21 ranges from 5 mm to 12 mm, inclusive; the length of the second portion 22 ranges from 4 mm to 10 mm, inclusive; or a ratio of the length of the first portion 21 to the length of the second portion 22 is greater than or equal to 1 and less than or equal to 2. The heating portion 11 is close to the closed end 23, and the electrically conductive portion 12 is close to the open end 24, so that when the heating element 1 is energized, the first portion 21 is heated to a higher temperature than that of the second portion 22. It may be understood that, the second portion 22 may cover the end of a portion of the heating portion 11 close to the electrically conductive portion 12, or the first portion 21 covers the end of a portion of the electrically conductive portion 12 close to the heating portion 11.

In some embodiments, the tube wall of the tube body 2 is spaced apart from the entire heating element 1. For example, a gap is reserved between the tube body 2 and the heating element 1. The gap may be filled with air. Certainly, it may be understood that, in some other embodiments, the gap may alternatively be filled with a reducing gas or an inert gas. By reserving the gap, there is no direct contact between the tube body 2 and the heating element 1. In some embodiments, the heating element 1 may alternatively be partially spaced apart from the tube wall of the tube body 2. Specifically, the radial dimension of a partial segment of the heating portion 11 may be greater than the radial dimension of another partial segment, and the radial dimension of a partial segment of the heating portion 11 may be equal to the inner diameter of the tube body 2, thereby achieving a position limiting function. Certainly, it may be understood that, in some embodiments, the inner side of the tube body 2 may partially project toward the heating element 1 to contact the heating element 1, thereby achieving a position limiting function. Certainly, it may be understood that, in some other embodiments, an isolating and positioning structure may be disposed on the heating element 1 or the tube wall of the tube body 2, so that the heating element 1 is not in direct contact with the tube wall of the tube body 2. For example, a ceramic ring, etc. is sleeved on the partial segment of the heating element 1. It needs to be noted that the foregoing gap may refer to a gap accessible to air, and does not mean that air or another gas necessarily exists. A vacuum state is also a form of the gap. To obtain a better vaping experience and prolong a service life of the heating element, the tube body 2 may also be provided with a vacuum or sealed at the open end.

The temperature at which the entire heating structure heats the aerosol-generating substrate 200 may be configured by configuring the thickness of the tube wall and the spacing between the heating element 1 and the tube body 2. Under the same temperature, as the thickness of the tube wall increases, the overall irradiance may tend to decrease. Optionally, in some embodiments, the thickness of the tube wall of the tube body 2 ranges from 0.15 mm to 0.6 mm, inclusive. In some embodiments, as the spacing between the heating element 1 and the tube wall increases, the temperature of the heating structure may tend to gradually decrease. Preferably, in some embodiments, the spacing between the tube wall of the tube body 2 and the heating element 1 may range from 0.05 mm to 1 mm, inclusive.

In some embodiments, the heating element 1 may rapidly heat up to the operating temperature after the aerosol-generating device is activated. The operating temperature in this application refers to the temperature of the heating element 1 itself when the heating element 1 heats the aerosol-generating substrate 200. Specifically, the operating temperature refers to the temperature of the heating element 1 itself when the heating element 1 excites the infrared radiation layer 14 to radiate infrared light. The operating temperature may not be unique in practice and may be related to factors such as the length of the vaping time, the frequency of vapings in the same time period, and the type of the aerosol-generating substrate 200. Specifically, the operating temperature of the heating portion 11 ranges from 500° C. to 1200° C., inclusive, which is beneficial for rapidly generating aerosol at the first puff. That is, the operating temperature of the heating element 1 during the entire working period can be any temperature between 500° C. and 1200° C., which depends on the temperature control requirements. The average operating temperature of the heating portion 11 ranges from 600° C. to 800° C., inclusive, which is beneficial for generating infrared radiation having a wavelength in a range of about 2 to 4.75 micrometers to heat the aerosol-generating substrate, thereby achieving effective aerosol generation of the main component of the aerosol-generating substrate. The operating temperature of the electrically conductive portion 12 ranges from 150° C. to 450° C., inclusive, and the average operating temperature is less than 300° C. In this way, it is beneficial for connecting leads to a circuit board without exporting excessive heat, which otherwise results in a risk of overheat failure or a reduced life of a component on the circuit board. The operating temperature of the first portion 21 is 350° C. to 550° C., inclusive, and the average operating temperature ranges from 280° C. to 370° C., inclusive. The maximum operating temperature of the second portion 22 is less than or equal to 250° C., and the average operating temperature is less than 200° C.

Preferably, the heating portion 11 is a heating wire made of a high-temperature resistant alloy material such as an iron-chromium-aluminum alloy, an iron-chromium alloy, or the like. The electrically conductive portion 12 is a lead made of a material with low resistivity, such as nickel, silver, copper, aluminum, or the like. The heating portion 11 and the electrically conductive portion 12 are connected by means of soldering, thereby forming a connection portion 13 therebetween. The diameter of the connection portion 13 is greater than the diameter of the electrically conductive portion 12. The connection portion 13 is located below the aerosol-generating substrate. Preferably, the connection portion 13 is located below the end surface of the aerosol-generating substrate. Because the electrically conductive portion 12 is made of an electrode material with low resistivity, the temperature of the electrically conductive portion 12 is lower than that of the heating portion 11 when the current flowing therethrough is the same.

In some embodiments, the heating portion 11 includes a plurality of spiral segments 11a connected in sequence. The plurality of spiral segments 11a are connected in sequence. The lengths of the spiral segments 11a range from 5 mm to 12 mm, inclusive, and the gaps between the spiral segments 11a and the inner wall of the tube body 2 range from 0.05 mm to 0.5 mm, inclusive. In some embodiments, a top end and a pin end are respectively disposed at two ends of the heating portion 11, the pin end is electrically connected to the electrically conductive portion 12, the top end is in contact with or spaced apart from the inner wall of the closed end, and the temperatures of at least some of the spiral segments 11a are higher than the temperatures of the top end and the pin end. In the present embodiment, the radial dimensions of each of the spiral segments 11a are set equally. In some other embodiments, the radial dimensions of each of the spiral segments 11a are not completely equal or are completely unequal. By adjusting the radial dimensions of the spiral segments 11a, the temperature field of the entire heating structure 11a may be configured. In the present embodiment, the diameter of the heating element 1 may range from 0.05 mm to 0.7 mm, inclusive. In some other embodiments, the radial dimensions of some of the plurality of spiral segments 11a may be greater than the radial dimensions of the other of the plurality of spiral segments 11a. For example, the plurality of spiral segments 11a may be configured such that the radial dimensions of the spiral segments 11a disposed at or near a middle portion are greater than the radial dimensions of the spiral segments 11a disposed at or near the two ends, or the plurality of spiral segments 11a may be configured such that the radial dimensions of the spiral segments 11a disposed at or near the middle portion are smaller than the radial dimensions of the spiral segments 11a disposed at or near the two ends.

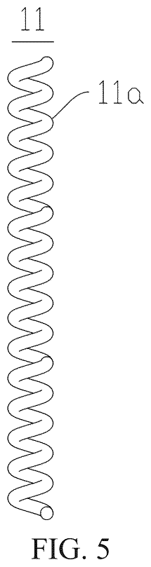

FIG. 5 shows a first embodiment of the heating portion 11 according to the present invention. The plurality of spiral segments 11a are equidistantly distributed. A first high-temperature zone of 2 mm to 5 mm is formed in the middle of the heating portion 11, and the operating temperature of the first high-temperature zone ranges from 550° C. to 1200° C. A second high-temperature zone is formed in the remaining area at two ends of the heating portion 11, and the operating temperature of the second high-temperature zone ranges from 500° C. to 900° C.

Certainly, it can be understood that, in some other embodiments, the plurality of spiral segments 11a are not limited to being equidistantly distributed. The plurality of spiral segments 11a may form dense segments having a length of 2 mm to 8 mm (inclusive) and a pitch of 0.05 mm to 0.7 mm (inclusive), and sparse segments having a length of 2 mm to 8 mm (inclusive) and a pitch of 0.6 mm to 1.5 mm (inclusive). The dense segments are the first high-temperature zone, and the temperature of the first high-temperature zone ranges from 550° C. to 1200° C., inclusive. The sparse segments are the second high-temperature zone, and the temperature of the second high-temperature zone ranges from 500° C. to 900° C., inclusive.

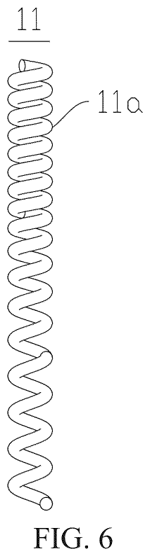

FIG. 6 shows a second embodiment of the heating portion 11 of the present invention, which differs from the first embodiment in that the spiral segments 11a in the upper half of the heating portion 11 form dense segments, and the spiral segments 11a in the lower half of the heating portion 11 form sparse segments.

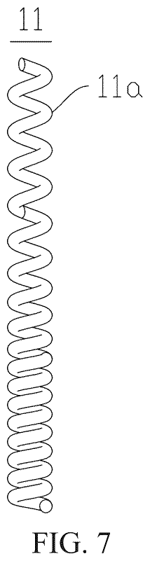

FIG. 7 shows a third embodiment of the heating portion 11 of the present invention, which differs from the first embodiment in that the spiral segments 11a in the upper half of the heating portion 11 form sparse segments, and the spiral segments 11a in the lower half of the heating portion 11 form dense segments.

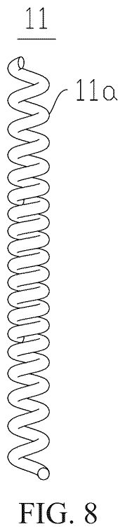

FIG. 8 shows a fourth embodiment of the heating portion 11 of the present invention, which differs from the first embodiment in that the spiral segments 11a in the middle of the heating portion 11 form dense segments, and the remaining spiral segments 11a at two ends of the heating portion 11 form sparse segments.

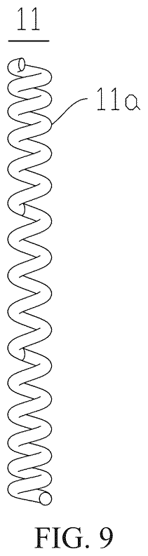

FIG. 9 shows a fifth embodiment of the heating portion 11 of the present invention, which differs from the first embodiment in that the spiral segments 11a in the middle of the heating portion 11 form sparse segments, and the remaining spiral segments 11a at two ends of the heating portion 11 form dense segments.

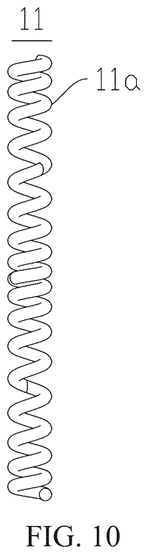

FIG. 10 shows a sixth embodiment of the heating portion 11 of the present invention, which differs from the first embodiment in that the spiral segments 11a of the heating portion 11 form a plurality of dense segments and sparse segments that are alternately distributed.

It can be understood that, the pitches of the plurality of spiral segments 11a can also change evenly from dense to sparse from top to bottom, or the pitches of the plurality of spiral segments 11a can change evenly from dense to sparse from the middle to both ends, so that the temperature of the heating portion 11 changes evenly from top to bottom or from the middle to both ends.

For heating elements of the same material and uniform diameter, the overall temperature field distribution can be controlled by adjusting the spacing distribution between the spiral segments 11a, that is, different first high-temperature zone and second high-temperature zone are formed to configure the overall temperature field of the heating portion 11, thereby generating different first puff aerosol generation amounts of the aerosol-generating substrate and different vaping experiences. It should be noted that the overall temperature field distribution is related to the density of the multi-segment spiral segments 11a, and the winding method with different density degrees of the spiral segments 11a may be selected according to the requirements of the temperature field distribution and the heating state during the overall heating process of the aerosol-generating substrate.

In general, the smaller the spiral pitch, the greater the heat generated by the same length, the higher the temperature and the stronger the infrared radiation. However, for the two ends, since the heat dissipation area is larger than that in the middle, the temperature is lower with the same spiral pitch. In order to achieve overall temperature uniformity, the pitch at the two ends should be small and the pitch in the middle should be large. However, the aerosol generation effect of the aerosol-generating substrate may not be the best under uniform temperature field conditions, and it should also be combined with the influence of other factors such as airflow. Therefore, different spiral structures can be set to achieve temperature field control.

Certainly, it may be understood that in some other embodiments, the overall temperature field distribution may alternatively be controlled by controlling the resistance, and the resistance control may be performed by selecting the material of the heating element 1 or controlling different diameters, that is, selecting the heating element 1 with a corresponding material and a corresponding diameter according to requirements. Preferably, the resistivity may be controlled to 0.8 Ωmm²/m to 1.6 Ωmm²/m, inclusive.

In some embodiments, the heating structure further includes an insulation member 3 at least partially disposed in the tube body 2 to insulate the electrically conductive portion 12. The electrically conductive portion 12 is led out from one end of the insulation member 3 for connection to a power supply end. Specifically, the insulation member 3 is provided with a position limiting hole for the electrically conductive portion 12 to pass through, and the diameter of the position limiting hole is smaller than that of the connection portion 13, thereby limiting the electrically conductive portion 12 inside the tube body 2.

In some embodiments, the heating structure further includes a mounting base 4 for fixing the tube body 2 in the aerosol-generating device, and the mounting base 4 is located in the second portion 22. The heating element 1 further includes the mounting base 4, and the distance between the mounting base 4 and the connection portion 13 ranges from 2 mm to 10 mm, inclusive. During operation of the heating element 1, the temperature of the mounting base 4 is less than 200° C., and the temperature conducted from the mounting base 4 to a housing of the aerosol-generating device is less than 45° C. Preferably, by increasing the distance between the mounting base 4 and the connection portion 13 or performing heat insulation treatment on the mounting base 4, the temperature of the mounting base 4 can be reduced to below 100° C., and the temperature of the housing of the aerosol-generating device can be reduced to below 38° C.

The present invention solves the problem where the direct connection the heating wire to the circuit board causes the heat to be directly transferred to the circuit board due to the excessive temperature of the heating wires is too high, resulting in the risk of the excessive temperature of the circuit board, which shortens the life of electronic components or leads to their burnout. By setting up the low temperature zone lead, the exportion temperature of the connected circuit board is reduced, avoiding the problem of the excessive temperature of the circuit board, and also indirectly reducing the temperature of the housing of the aerosol-generating device.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heating structure, comprising:
a heating element; and
a tube body,
wherein the heating element and a tube wall of the tube body are at least partially spaced apart,
wherein the heating element is electrically heated and configured to radiate infrared light to transmit through the tube body and heats an aerosol-generating substrate,
wherein the tube body comprises a first portion and a second portion that are distributed along an axial direction of the tube body, and
wherein the first portion and the second portion are configured, such that, when the heating element is energized, the first portion reaches a higher temperature than a temperature than the second portion.

2. The heating structure of claim 1, wherein the tube body comprises a closed end and an open end,
wherein the heating element extends into the tube body from the open end and is in contact with or spaced apart from the closed end,
wherein the first portion is close to the closed end, and
wherein the second portion is close to the open end.

3. The heating structure of claim 2, wherein a maximum operating temperature of the first portion ranges from 350° C. to 550° C., and
wherein a maximum operating temperature of the second portion is less than or equal to 250° C.

4. The heating structure of claim 3, wherein a length of the first portion is greater than or equal to a length of the second portion.

5. The heating structure of claim 4, wherein the length of the first portion ranges from 5 mm to 12 mm, and the length of the second portion ranges from 4 mm to 10 mm, or
wherein a ratio of the length of the first portion to the length of the second portion is greater than or equal to 1 and less than or equal to 2.

6. The heating structure of claim 2, wherein the heating element is longitudinally disposed,
wherein the heating element comprises a heating portion close to the closed end and an electrically conductive portion connected to the heating portion, and
wherein a ratio of a length of the first portion to a length of the heating portion is greater than or equal to 0.8 and less than or equal to 1.5.

7. The heating structure of claim 6, wherein a maximum operating temperature of the heating portion ranges from 500° C. to 1200° C., and
wherein a maximum operating temperature of the electrically conductive portion ranges from 150° C. to 450° C.

8. The heating structure of claim 6, wherein the heating portion comprises at least a plurality of spiral segments connected in sequence.

9. The heating structure of claim 8, wherein a top end and a pin end are respectively disposed at two ends of the heating portion,
wherein the pin end is electrically connected to the electrically conductive portion,
wherein the top end is in contact with or spaced apart from an inner wall of the closed end, and
wherein temperatures of at least some of the spiral segments of the plurality of spiral segments are higher than temperatures of the top end and the pin end.

10. The heating structure of claim 8, wherein lengths of spiral segments of the plurality of spiral segments range from 5 mm to 12 mm, and
wherein a gap between the spiral segments and an inner wall of the tube body ranges from 0.05 mm to 0.5 mm.

11. The heating structure of claim 8, wherein the plurality of spiral segments are disposed equidistantly or in an alternating sparse-dense pattern.

12. The heating structure of claim 6, further comprising:
a mounting base configured to fix the tube body,
wherein the mounting base is located at the second portion,
wherein the heating element comprises a connection portion connecting the heating portion and the electrically conductive portion, and
wherein the mounting base is located between the open end and the connection portion in the axial direction of the tube body and is spaced apart from the connection portion.

13. The heating structure of claim 12, wherein a distance between the connection portion and the mounting base ranges from 2 mm to 10 mm.

14. The heating structure of claim 6, wherein the second portion covers the end of a portion of the heating portion close to the electrically conductive portion.

15. The heating structure of claim 6, wherein the first portion covers the end of a portion of the electrically conductive portion close to the heating portion.

16. The heating structure of claim 1, wherein the tube body is configured to be at least partially inserted into the aerosol-generating substrate, and
wherein the infrared light generated by the heating element is transmitted through the tube body and heats the aerosol-generating substrate.

17. The heating structure of claim 1, wherein the heating element comprises a heating substrate and an infrared radiation layer disposed on the outer surface of the heating substrate, and
wherein the heating substrate is electrically heated and configured to excite the infrared radiation layer to radiate infrared light.

18. An aerosol-generating device, comprising:
the heating structure of claim 1; and
a power supply assembly configured to supply power to the heating structure.
